(19) United States
(12) Patent Application Publication
(10) Pub. No.: US 2003/0110227 A1
(43) Pub. Date: Jun. 12, 2003

(54) Real time streaming media communication system

(76) Inventor: Timothy Patrick O'Hagan, Fort Myers, FL (US)

Correspondence Address: TIMOTHY P. O'HAGAN, 8710 KILKENNY CT, FORT MYERS, FL, 33912, US

(21) Appl. No.: 10/310,456

(22) Filed: Dec. 5, 2002

Related U.S. Application Data
(60) Provisional application No. 60/340,475, filed on Dec. 6, 2001.

(51) Int. Cl. G06F 15/16

(52) U.S. Cl. 709/206

(57) ABSTRACT

The present email integration and management system comprises a management engine that interfaces with both incoming and stored electronic message files. A comparison engine compares contents of an incoming electronic message file to contents of each of a plurality of stored electronic message files using predefined comparison parameters to identify a stored electronic message file to which the incoming electronic message file relates. An extraction engine identifies a new portion of the contents of the incoming electronic message file that is not already included in contents of the stored electronic message file and the management engine appends the new portion of the contents of the stored electronic message file.

### RELATED APPLICATIONS

The present application is a continuation-in-part of U.S. Provisional Patent Application No. 60/230,475, entitled Coherent Email Integration and Management System, filed on Dec. 6, 2001. The contents of such allocation is incorporated herein in its entirety.

### TECHNICAL FIELD

The present invention relates generally to data management, and more particularly to management of a plurality of interrelated email messages.

### BACKGROUND OF THE INVENTION

Email messaging has become one of the most commonly used written communication mediums of modern time.

The primary benefit of e-mail over other written forms of communication is the speed at which it is delivered to the recipient. In most cases, an e-mail message will be delivered to any recipient world wide within a matter of seconds of when it is sent. Even the speed of a fax machine can not compete with the speed of e-mail. Further, an email is delivered securely to the recipients computer-no matter where in the world the computer may be located so long as internet e-mail access is available and the e-mail may may include a file attachment that can be opened and edited by the recipient. Fax machines (and the telephone number used to reach a destination fax machine) typically are not mobile and fax machines have no mechanism for transmitting an electronic file. So much are the benefits of e-mail over fax machines that fax servers now exist that will convert an incoming fax to e-mail and deliver to the recipients in-box as e-mail.

The ease of use and rapid delivery speed that have made email such a highly adopted technology have also made e-mail a communication medium for text based conversations. It is common for users of email to sequentially “reply”, “reply-all” and/or “forward” emails to multiple recipients, cc-recipients, and bcc-recipients” many times. A person who is a cc-recipient on an e-mail that is forwarded or replied to many times may have his or her inbox filled with 10 or more emails that are all related to the same topic and which, in the aggregate, represent a text based conversation.

Email technology is not well suited for text based conversations. Each use of the “reply”, “reply-all” and/or “forward” command causes an email client to copy the contents of the previous message (which itself may include contents of a previous message) into the reply or forward message. Various clients copy the previous email using various formatting systems including but not limited to adding the newly authored material at the top and the copied material at the bottom, adding the copied material at the top and the newly authored material at the bottom, and highlighting the copied material with “>” or other characters.

As a result, sequential use of reply”, “reply-all” and/or “forward” by multiple participants rapidly generates an inbox full of many emails. Each such email includes copied text from other emails in different orders and with different formatting. The quantity of email messages, the quantity of redundant text, the inconsistent formatting, and the inconsistent sequencing makes review and comprehension of the text conversation difficult.

Other electronic communication technologies are much better suited to text based conversations, but have not been as widely adopted as email. Such technologies include instant messaging, chat rooms, and bulletin boards.

Instant messaging technology enables two conversation participants to type text into an instant message window that is simultaneously viewed by both conversation participants. All text within the instant message window is in chronological order. As such, a person may simply read from the top of the window to the bottom of the window and comprehend the entire conversation.

Instant messaging is becoming popular in the business world for replacing oral communications between two people, but email remains the preferred technology for several reasons. First, the record of the conversation is lost when the instant message window is closed (or at least not easily located and retrieved within an organized structure). Secondly, the instant message conversation is limited to only two people with no readily available solution for copying third people or inviting participation by third people.

Chat room technology enables multiple conversation participants to type text into a chat room window that is simultaneously viewed by all participants in the chat room. It can be thought of as an instant message window that is simultaneously amongst several participants. The problems with chat room technology is that there are no attachments, the record is lost when the window is closed, and there is no security. Each person with access to the chat room window will be able to view all of the history of the conversation (e.g. there is no mechanism for blocking certain precipitants for seeing certain messages). Chat room technology has not been widely adopted amongst business users.

Bulletin board technology enables multiple conversation participants to post messages to a bulletin board file. Each participant with access to the bulletin board file can review the messages in order. Attachments may be added to the message in fact, each message may be an email message sent to the bulletin board destination. The primary problem with bulletin board technology is security. Each person with access can review all messages. As such, bulletin board technology has been adopted primarily for public topics where restricting access is not an issue.

Known email clients have limited capabilities in managing email messages in a matter that helps facilitate comprehension of a plurality of emails with the same subject line header

Turning to FIGS. 1a and 1b, the known file folder structure provided by typical email clients includes an in box 82 and a sent items box 80 are shown. The inbox 82 is a display that represents a list of email messages received by the email client from various remote senders. The sent items box 80 is a display that represents a list of email messages sent by the email client to various remote recipients.

For purposes of illustration, a total of five email messages that all relate to the topic “partner's proposal” are included in a combination of the inbox 82 and the sent items box 80. Email 81 represents an original email sent by the email client to a plurality of remote recipients and the remaining four emails with a subject header of “re: partner's proposal” represent an email that was generated by the email client (or a remote email client) by activation of a “reply”, “reply-all”, or “forward” control. It should be appreciated that such a “reply”, “reply-all”, or “forward” may be utilized on the original message or on a message itself that is a “reply”, “reply-all”, or “forward” of either the original message or yet another “reply”, “reply-all”, or “forward” message. It is common to have a “reply”, “reply-all”, or “forward” email message that is part of a message that has been replied to or forwarded multiple times.

For example, referring briefly to FIGS. 2a and 2b, a typical email 11 includes at least two previous email messages 129b and 129c embedded therein.

Utilizing known controls within typical email clients, a user may individually open each email to review its contents, create file folders, move emails into and out of each created file folder, sort the inbox, sort the sent items folder, (or sort any other file folder) by topic, sort the inbox, sort the sent items folder, (or sort any other file folder) chronologically, and even view a fixed length first portion of the textual body of an email in an auto-preview mode without opening the email.

Known email organizers may even automatically locate emails with matching subject line headers and automatically move such emails to a dedicated file folder.

The problems is, even with these known capabilities, it is not easy for a user to quickly extract a text based conversation from multiple inter-related emails for the following reasons: First, if any email within the conversation includes a header that was changed by the email author, the above described systems will not include the email with other related emails in a sort by subject header or in a dedicated file folder based on the subject header. Secondly, each email message may include much redundant content that has been automatically copied into the email by the author's email client in response to use of the “reply”, “reply-all” and “forward” commands. A reader will still need to read each email in its entirety to detect new content within the redundant content. And thirdly, the auto-preview pane provides a fixed length portion of the first part of the text only. This fixed portion is independent of whether that portion is newly authored text, text copied from a previous email, or a portion of both.

What is needed is an email integration and management system that enables an email recipient to view relevant portions of multiple related messages in a managed order and format that does suffer the disadvantages of known systems.

### SUMMARY OF THE INVENTION

A first aspect of the present invention is to provide an email transcript engine. The email transcript engine comprises a file management engine, a comparison engine and an extraction engine. The comparison engine provides for comparing text within a body of at least two email files to identify a related group of email files. The related group of email files comprises at least two email files that include an identical string of text. The extraction engine provides for determining a unique content portion of the body of each of the email files within the related group and a redundant content portion of the body of each of the email files within the related group.

The unique content portion is the portion of the body input by the sender of the email. The redundant content portion is the portion of the body copied from a previous email file in response to activation of one of the email client software's “forward”, “reply”, and “reply-all” controls.

The file management engine provides for generating a transcript document. The transcript document comprises a chronological sequence of each unique content portion of the body portion of each of the email files within the related group. Generating the transcript document may comprise inserting each unique content portion into pre-defined fields within a transcript document template.

The transcript document may further comprise identification of the author of each unique content portion in association with such unique content portion. The identification of the author may include inserting a text string from the from header of each email into pre-defined fields within the transcript document template.

The transcript document may further comprise an active link associated with each unique content portion of each body portion and providing a link to the redundant content portion of such body portion.

At least one of the at least two emails may be located within an inbox file controlled by an email client and, at least one of the at least two emails may be located within a sent items file controlled by an email client.

The file management engine may further generate a transcript email that includes the transcript document in a body portion of a transcript email and stores the transcript email within an email file storage controlled by an email client. The file management engine may further create a new directory associated with the related group of email files and move each of the related group of email files to the new directory.

A second aspect of the present invention is to provide an email client comprising: a) means for exchanging email messages with a remote email server; b) means for storing email messages received from a remote server in a file structure that includes an inbox file; c) means for storing email messages sent to a remote server in a sent items file within the file structure; and d) a file management engine comprising a comparison engine and an extraction engine.

The comparison engine provides for comparing text within a body of a plurality of email messages stored within the file structure to identify a related group of email files. The related group of email files comprises at least two email files that include an identical string of text. The extraction engine provides for determining a unique content portion of the body of each of the email files within the related group and a redundant content portion of the body of each of the email files within the related group. The unique content portion is the portion of the body input by the sender of the email and the redundant content portion is the portion of the body copied from a previous email file in response to activation of one of the email client software's “forward”, “reply”, and “reply-all” controls. The file management engine generates a transcript document that comprises a chronological sequence of each unique content portion of the body portion of each of the email files within the related group.

The transcript document may further comprise identification of the author of each unique content portion in association with such unique content portion. The identification of the author may include inserting a text string from the from header of each email into pre-defined fields within the transcript document template.

The transcript document may further comprise an active link associated with each unique content portion of each body portion and providing a link to the redundant content portion of such body portion.

At least one of the at least two emails may be located within the inbox file and at least one of the at least two emails may be located within the sent items file.

The file management engine may further generate a transcript email that includes the transcript document in a body portion of a transcript email and stores the transcript email within the inbox. The file management engine may further create a new directory associated with the related group of email files and move each of the related group of email files to the new directory.

A third aspect of the present invention is to provide a method of email management that comprises: a) receiving an email from a remote email service provider; b) retrieving a stored transcript email that is related to the incoming email; c) comparing contents of the email with the transcript email to identify a unique portion of the body of the email and to identify a redundant portion of the body of the email; and d) creating an appended transcript document by appending only the unique portion of the email to the transcript document.

The method may further comprise storing the email in a file directory associated with the transcript document and which includes a plurality of other emails associated with the transcript document.

The step of retrieving a stored transcript document may include comparing a text string from the email with text within each of a plurality of transcript documents and retrieving a transcript document that includes a text string that matches the text string from the email.

The method may further comprise storing the appended transcript document in an inbox folder and moving the transcript document to a deleted items folder.

For a better understanding of the present invention, together with other and further aspects thereof, reference is made to the following description, taken in conjunction with the accompanying drawings. The scope of the invention is set forth in the appended claims.

### BRIEF DESCRIPTION OF THE DRAWINGS

FIG. 1a is a representation of a list of messages stored in a sent box file in known email client systems;

FIG. 1b is a representation of a list of messages stored in an in box file in known email client systems;

FIGS. 2a and 2b represent a typical known email that includes a plurality of previous email messages embedded therein;

FIG. 3 is a diagram of an email integration and management system in accordance with the present invention;

FIG. 4a is a diagram representing an integrated and organized transcript document in accordance with one embodiment of the present invention;

FIG. 4b is a diagram representing an integrated and organized transcript email that includes a transcript documents in accordance with one embodiment of the present invention;

FIG. 5a is a diagram representing an alternative integrated and organized transcript email that includes an alternative transcript documents in accordance with one embodiment of the present invention;

FIG. 5b represents the alternative transcript email of FIG. 5a following user activation of links to view archived content in accordance with one embodiement of the present invention;

FIG. 6 is a flow chart representing exemplary operation of an email integration and management system in accordance with one embodiment of the present invention;

FIG. 7 is a flow chart representing exemplary operation of an email integration and management system in accordance with one embodiment of the present invention;

FIG. 8 is a diagram of a transcript document template in accordance with one embodiment of the present invention;

FIGS. 9a and 9b are a diagram representing folder structure in accordance with one embodiment of the present invention; and

FIG. 10 is a flow chart representing exemplary operation of an email integration and management system in accordance with one embodiment of the present invention.

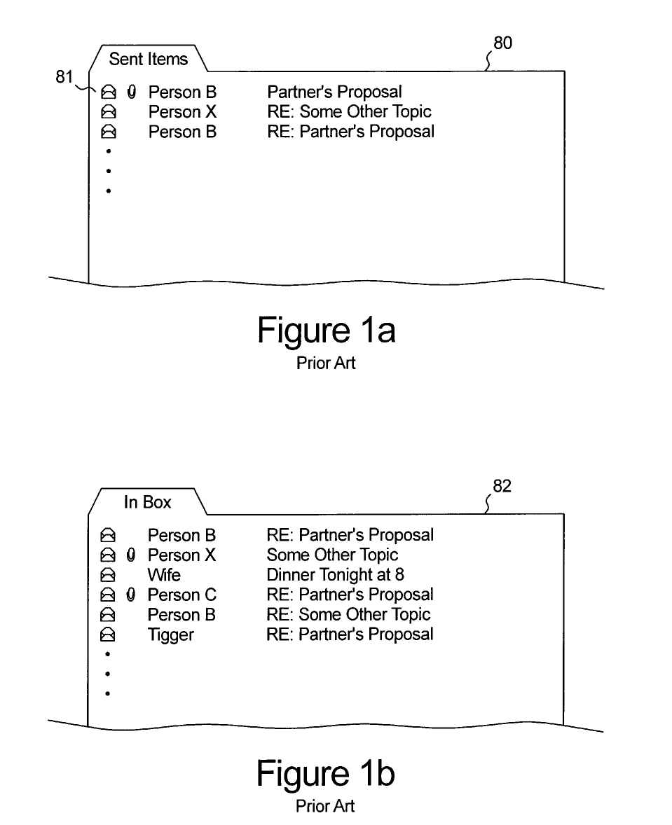

### DESCRIPTION OF THE PREFERRED EMBODIMENTS

The present invention will now be described in detail with reference to the drawings. In the drawings, like reference numerals are used to refer to like elements throughout.

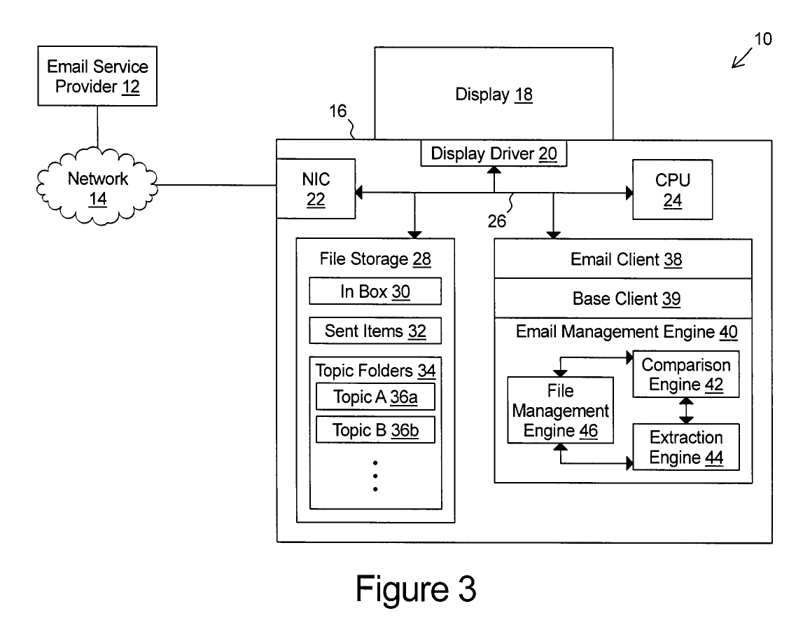

Referring to FIG. 3, an email integration and management system 10 is shown operating in conjunction with an email service provider 12 coupled to the system 10 through a network 14.

The network may be a TCP/IP compliant network such as the Internet, a local IP subnet, or a combination of both.

The email service provider may be a known email server system such as an Internet mail server system which may include a combination of a POP server(s) and an SMTP server(s), a server known by the trade name Exchange provided by Microsoft Corporation, or a server known by the trade name Lotus Notes provided by IBM Corporation.

The system 10 may be embodied on a traditional computer system that includes a CPU 24, a display 18, a display driver 20, a network interface circuit 22, file storage 28, and a memory 48 for software execution.

In the exemplary embodiment, an email client 38 resides in the memory 48 and is executed by the processor 24. The email client 38 comprises a base client system 39 and an email management engine 40.

The base client system 39 includes known systems for establishing a connection with the email service provider 12, sending messages to and receiving messages from the email service provider 12 via the network 14, and establishing email files, such as an inbox 30, a sent items file 32, and a plurality of topic files 36a and 36b stored under a topics folder 34 within the file storage 28 in known manners.

It should be appreciated that the inbox file 30, the sent items file 32, and the plurality of topic files 36a and 36b represent a logical organization of emails as represented by the email client 38 on the display 18 and the physical storage structure of the email files may include proprietary data structures including, but not limited to, storing multiple emails within bulk file structures such as files commonly known as .pst files and .ost files in the case of an email client known by the trade name Outlook and provided by Microsoft Corporation—or equivalent data storage files in the case of other clients such as an email client known by the tradename Lotus Notes and provided by IBM.

The base client system 39 also includes known systems for composing new email messages, viewing of header information and body information of emails when opened by a user, and replying and forwarding email messages, again in known manners.

The email management engine 40 may include a file management engine 46, a comparison engine 42, and an extraction engine 44 which, in combination provide for combining the contents of two or more related email messages to provide a transcript of a text based conversation within a single document while excluding all redundant content that may have been copied into each of the two or more email messages by various remote email client systems.

It should be appreciated that in this exemplary embodiment, the email management engine 40 operates in conjunction with the base client 39 with both together comprising the email client 38. However, it is envisioned that the functionality and structure of this invention could be integrated into any known email client structure and the scope of this invention is intended to cover an email client that includes the structure and/or methods of the present invention embodied therein.

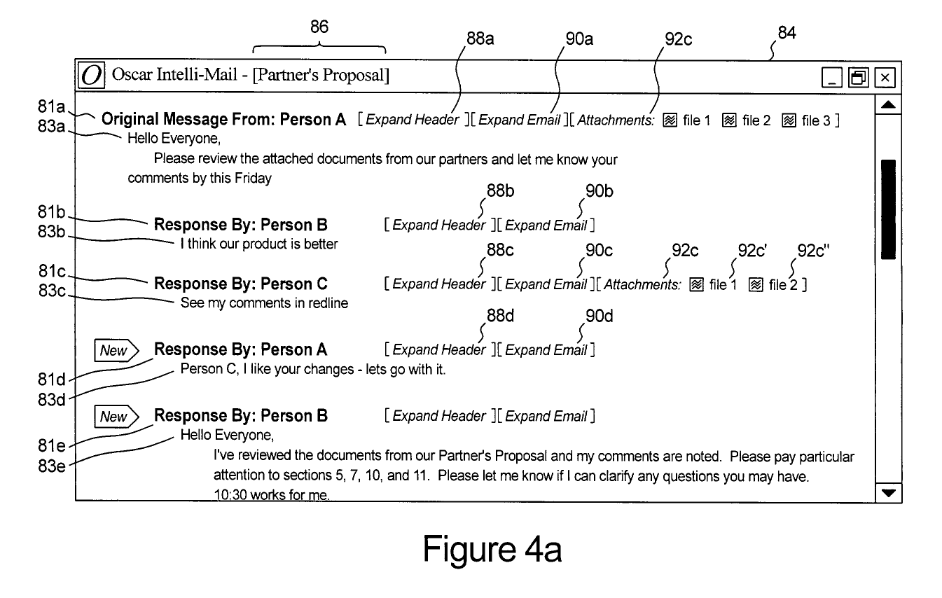

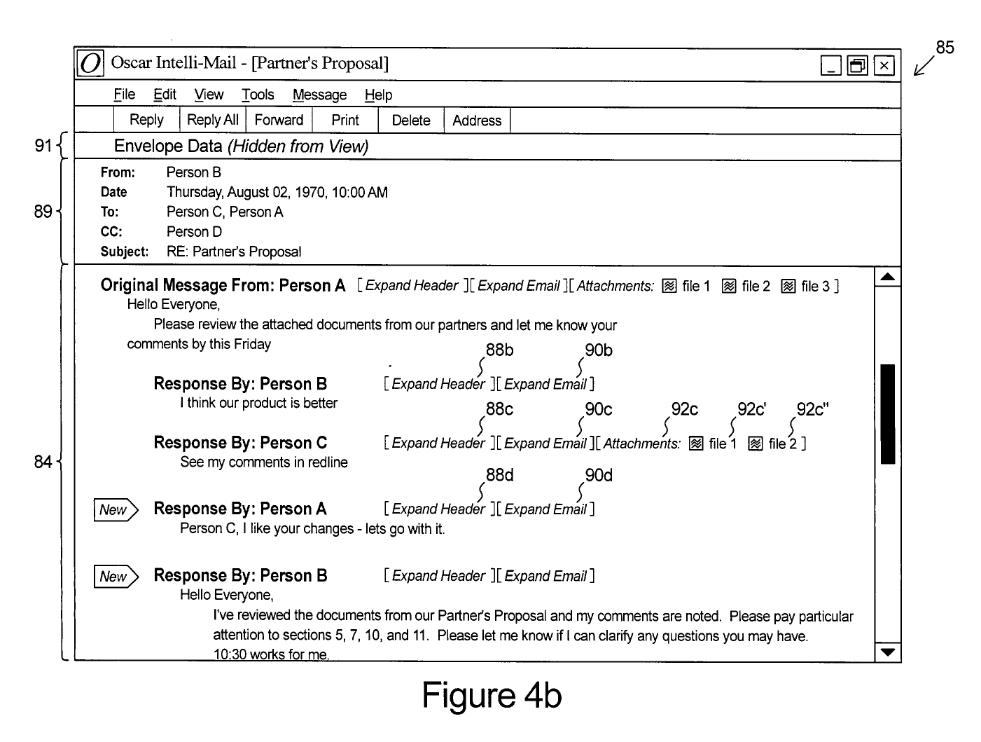

FIG. 4a represents an exemplary transcript in the form of a mark-up language transcript document 84. The transcript document 84 is an electronic document in a mark-up language format that provides for inclusion of both textual content and format/display control tags within the document that control formatting of the content, font, size, color and other display attributes that provide for an email client, or other viewer, to display the textual content in accordance with the format/display control tags such that the displayed document is the well formatted transcript document 84. Exemplary mark-up languages include HTML and XML.

The transcript document 84 comprises a display of a chronological sequence, from the top-downward, of a unique content portion of the body portion of each of the two or more email messages. For purposes of this discussion, the unique content portion means that portion of the body of an email message that was newly authored by the sender of the message, including portions manually pasted into the email by the sender and files attached by the sender. The unique content portion specifically excludes those portions of the body that were automatically copied into the body (and files that were automatically attached to the email) by the sender's email client by virtue of the sender utilizing the clients “forward”, “reply”, “reply-all”, or similar command. Those portions that were automatically copied into the body (and files that were automatically attached to the email) by the sender's email client by virtue of the sender utilizing the clients “forward”, “reply”, “reply-all”, or similar command may be referred to as redundant content portions of the body.

Chronologically sequencing only the unique content portion of the body portion of each email into a single transcript document 84 facilitates comprehension of overall contents of the entire sequence of emails and eliminates the manual and/or cognitive tasks of opening each email, sorting the contents to separate unique content from redundant content, and sequencing unique content to understand a text based conversation embodied in a plurality of interrelated emails.

The transcript document 84 also includes a topic name field 86 that corresponds to the topic that interrelates the sequential emails. And, in association each unique content portion 83a-83e is an indication 81a-81e of who authored the unique content portion 83a-83e, an expand-headers link 88a-88e, an expand-email link 90a-90e, and an expand-attachments link 92a-92c respectively.

Each of these links 88, 90, and 92 may include a link or other control code for either: a) expanding additional content that is embedded within the document 84, but suppressed from display unless and until the link is activated; or b) opening a new document identified by the link or control code which includes additional content.

For purposes of discussion, content that is embedded within the document 84, but suppressed from display unless and until a link is activated may be referred to as archived content.

The additional content associated with each expand-headers link 88a-88e may be the header information of the particular one of the at least two emails that includes the unique content portion 83a-83e associated with the link 88a-88e. The header information may include the identity of recipients to which the email was sent (including copy recipients and blind copy recipients) in at least one of a to, cc, and bcc header, the complete email address of the author of the unique content portion in a from header, and the subject line of the original email in a subject header.

The additional content associated with each expand-email link 90a-90e may include the entire body of the particular one of the at least two emails that includes the unique content portion 83a-83e associated with the link 90a-90e. In another embodiment, the content associated with each expand-email link 90a-90e may further include the header information.

The additional content associated with each attachments link 92a-92e may include the links to any attachments that are attached to the particular one of the at least two emails that includes the unique content portion 83a-83e associated with the link 92a-92e. In an alternative embodiment, the attachment links 92c′ and 92c″ may themselves be a link to a file attached to the email that includes the unique content portion 83c.

FIG. 4b represents an exemplary transcript in the form of Simple Mail Transport Protocol (SMTP) email 85 that includes that includes an envelope 91 and headers 89 in accordance with known email protocols and includes a body that comprises the mark-up language transcript document 84. The email 85 may be readily stored in the file storage 28 (FIG. 3), viewed through the base client 39, and forwarded to remote recipients by the base client 39. The transcript document 84 as included within the email 84 may be as discussed with reference to FIG. 4a.

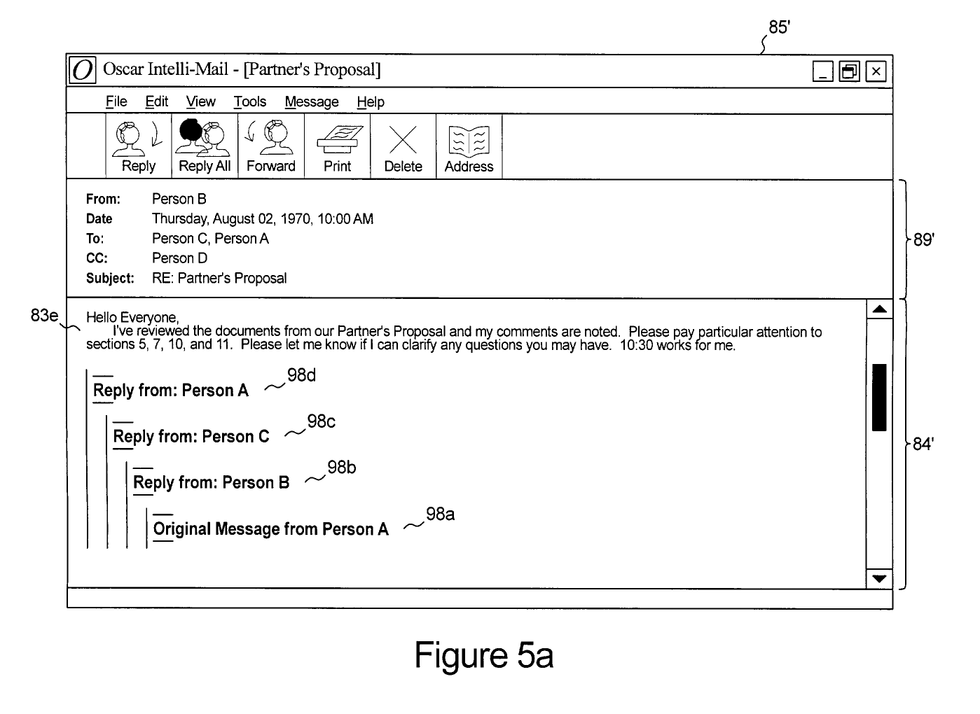

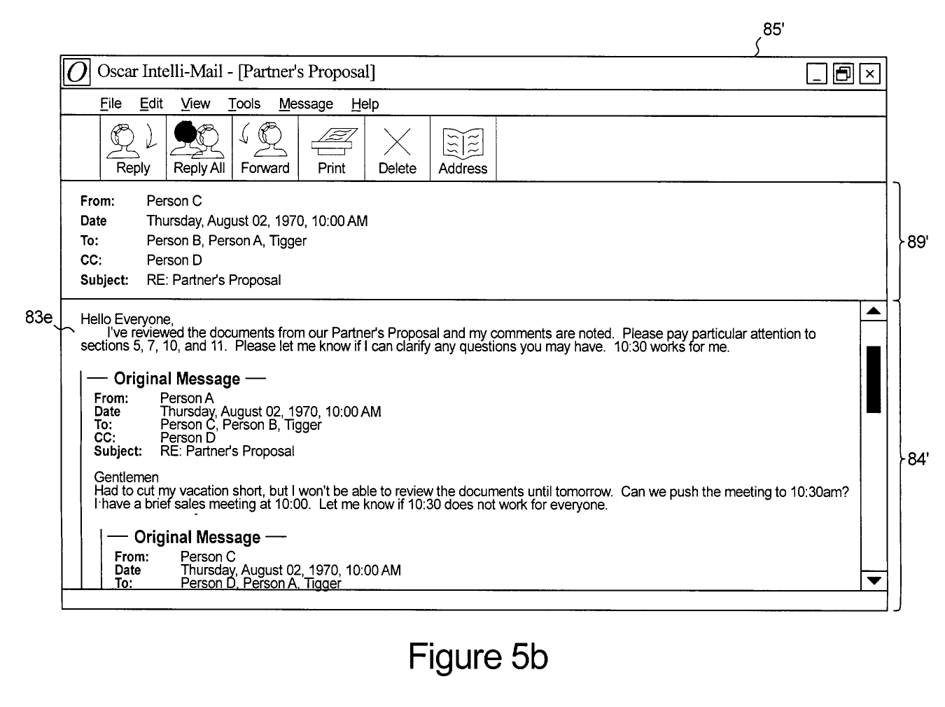

FIG. 5a represents an alternative transcript email 85′ (as viewed utilizing the base client 39) which includes an email envelop (not shown), an email header 89′, and an alternative transcript document 84′.

The alternative transcript document 84′ is organized in chronological sequence, from the bottom-upward, and includes the unique content portion 83e of the most recent email received and includes an expansion link 98a-98d to each previous email that is included within the transcript document 84′. In the alternative transcript document 84′, the entire contents of each email is embedded within the document 84′, as archived content, and is viewable upon activation of the expansion link 98a-98d associated therewith. FIG. 5b represents the alternative transcript email 85′ following expansion of at least links 98d and 98c.

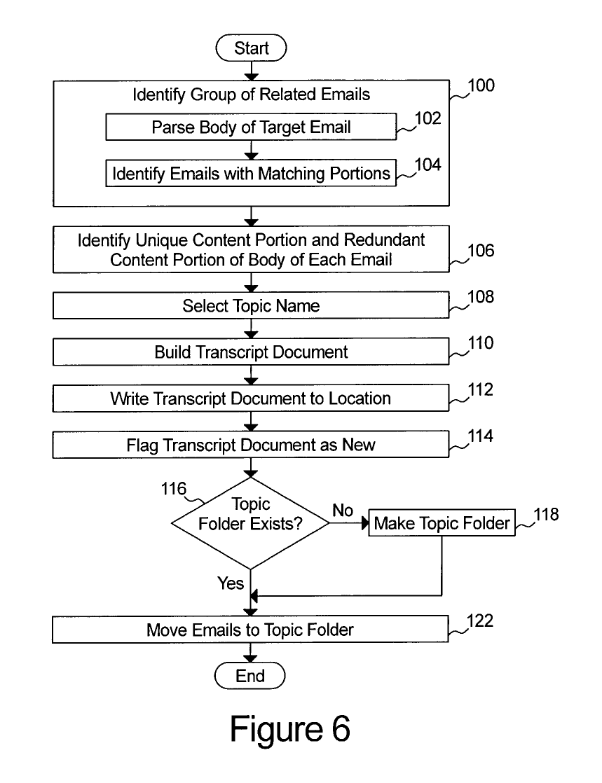

FIG. 6 is a flow chart representing exemplary operation of the email management engine 40 in generating a transcript document for a group of emails related to a target email.

Step 100 represents identifying a group of emails related to the target email. Identifying the group of emails may be performed simply by identifying all emails that include a subject header that matches, in whole or in substantial part, the subject header of the target email. However, it is common for an author of an email to change a “reply”, “reply-all”, or “forward” email subject header. Therefore, such a solution is not optimal in that related emails may not be properly identified. A more robust solution is represented by sub steps 102 and 104.

Sub step 102 represents the comparison engine 42 parsing the body portion of the target email to identify searchable text strings, and/or subject headers utilized in previous emails embedded in the target email (if any).

Searchable text strings may include strings of text with unique character combinations—of sufficient length, to enable rapid searching for matching strings in other emails and provide a low occurrence of false positive matches wherein the text string matches, but the email is unrelated. Searchable text strings may also include two levels of text strings. A first level may be a shorter string that provides for more rapid searching for matching strings in other emails and, if a short string is matched, a second level string may be a longer string that is used to search emails that matched the shorter string to eliminate false positives. It may also be beneficial to choose a searchable text string from a portion of the body of the target email identified to be the oldest known email copied into the body. Such text string, because it is part of the original email would, in theory, be in almost all of the related emails.

Following parsing to identify searchable text strings and subject headers, other emails within the inbox, the sent items file, and all other pertinent files are searched by the comparison engine 42 for matching text strings to identify such email as part of the group of related emails at step 104.

Step 106 represents the extraction engine 44 identifying the unique content portion and the redundant content portion of the body portion of each email identified as part of the group of related emails.

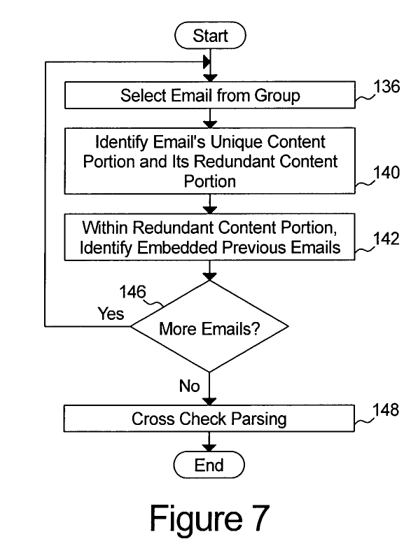

The flow chart of FIG. 7 represents exemplary processes for performing step 106. However, it should be appreciated that these processes are exemplary only and that those skilled in the art may readily choose other systems, or develop other systems, for identifying the unique content portion and the redundant content portion of the body portion of each email without departing from the scope of the present invention.

Step 136 represents selecting a first email within the group. Steps 140 and 142 represent parsing the selected email using formatting queues to identify the unique content portion of the body of the selected email, the redundant content portion of the body of the selected email, and to identify unique contents of other emails that are represented by the redundant content portion.

More specifically, step 140 may represent identifying the selected emails unique content portion by locating text patterns (such as text patterns for copied header information) that separate the unique content portion of the body from redundant content portions.

Step 142 represents identifying a unique content portion of each email copied into the redundant content portion of the first email by locating text patterns that separate the various emails within the redundant content portion.

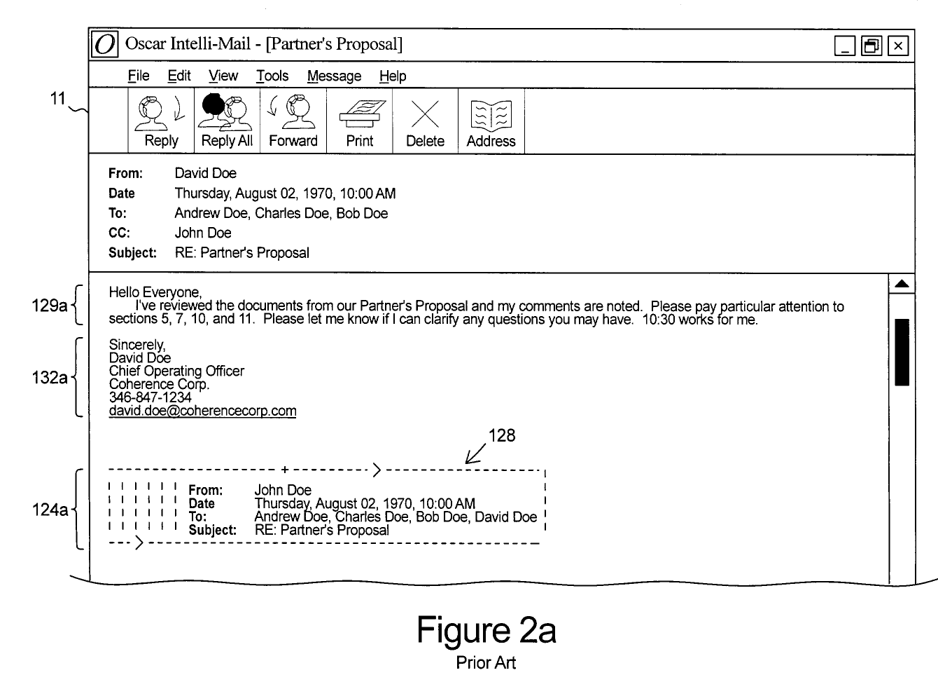

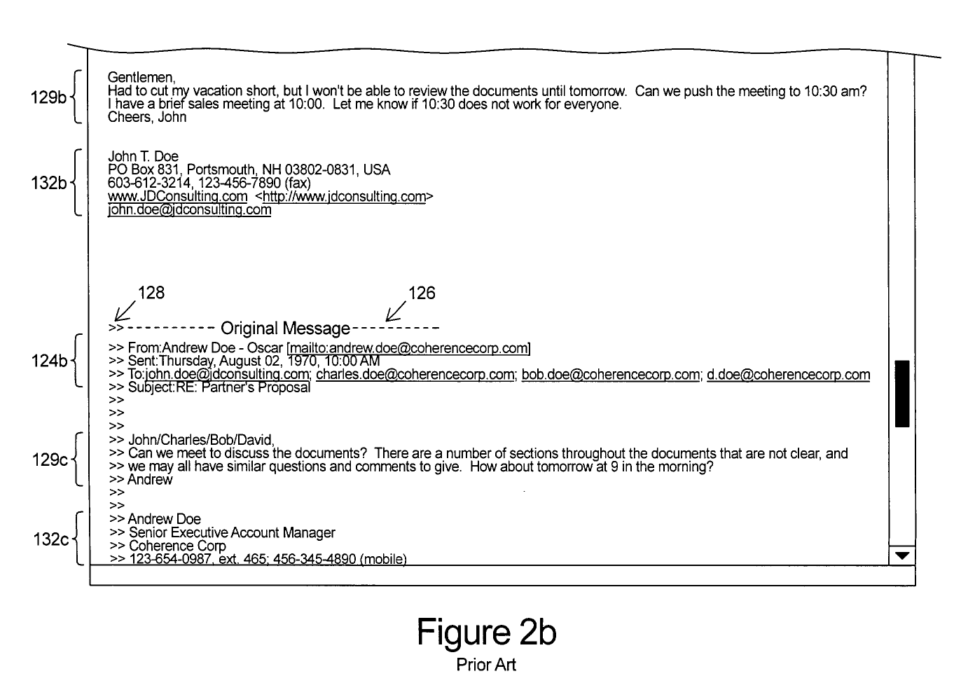

Exemplary techniques for recognizing text patterns to identify previous emails copied into an email are discussed by way of example of performing such recognition on the known email of FIGS. 2a and 2b. Step 142 may include recognizing specific characters recognizable as setting forth email header text within text copied from a previous email, a character string which defines the start of a message within text copied from a previous email, line markers, such as “>” symbols, which define text of an email within text copied from a previous email message, a text block which includes strings that indicate that the text block is the header of an email message within text copied form a previous email message, or a text block which includes strings that indicate that the text block is the “signature line” or end of an email message within text copied from a previous email message. A recognizable string within a “signature line” text block may be the name of a person that matches a string (being the name of the person) within a text block within the header of such email message.

For example, text blocks 132a, 132b, and 132c may each be recognized as a signature block due to one or more of the following characteristics: a) its spacing below the text block above the text block 132, b) its spacing above the text block below text block 132; c) its different formatting and/or font from the text block below the text block 132; d) its inclusion of a test string matching a commonly used complimentary closing such as “sincerely” or “yours truly”; e) a text string matching the text string within a “name” header of the email; f) its inclusion of a text string matching common positions or employment titles such as “chief operating officer” or “vice president”; g) its inclusion of a text string matching a domain name within the email header (indicating that it may be a company name); and h) its inclusion of a text string recognizable as one or more of a telephone, fax, or cell phone number; j) its inclusion of a text string recognizable as a mailing address by its combination of a two digit state code followed by a zip code (or other characteristics of a typical mailing address) and/or i) its inclusion of an email address with a text string that matches an email address within a from header of the email.

Text blocks 124a and 124b may be recognized as headers of email messages due to one or more of the following characteristics: a) its spacing below the text block above the text block 124; b) its spacing above the text block below text block 124; c) its spacing below a text block identified as a signature line 132; d) its different formatting and/or font from the text above the text block 124; e) inclusion of characters 128 that sets a portion of the email apart from other portions; f) inclusion of a text string matching a date and time format; and/or g) inclusion of a text string 126 recognizable as a common “start of message” text string; inclusion of a text string matching other header formats such as a “from” header, a “to” header, a “CC” header, a “BCC” header, “and/or a “RE” header.

Text blocks 129a, 129b, and 129c may be recognized as unique content based on positioning between a text block recognized as a header 124 and a text block recognized as a signature line.

Text block 129a specifically can be identified as unique content of the first email by its position within the body as the first text block and above the first signature line 132a (which includes a text string matching the name of the “from” header of the email.

Text block 129b can be identified as unique content of an email sent on Nov. 29, 2002 at 12:32 pm base on its positioning between block 124a and 132b. And, text block 129c can be identified as unique content of an email sent on Dec. 4, 2002 at 10:41 am by its positioning between block 124b and block 132c.

As such, it should be appreciated that following sub steps 140 and 142, the unique content of each of a plurality of emails that may have been copied into the first email have been identified.

If following step 140 there are additional emails within the group at step 146, steps 140 and 142 are repeated for a next email selected upon repeat of step 136. Following completion of steps 140 and step 142 for each email, step 148 represents cross checking the unique contents of each email (identified during each iteration of step 142) to verify the accuracy of each email. This cross check provides for additional robustness of the system. If during step 142 for the first email message, a text block is not properly recognized as unique content of an independent email, such text block may be recognized as an independent email in another iteration of step 142.

Returning to FIG. 6, after the unique content portion of each email within the group is identified at step 106, step 108 represents selecting a topic name for the group of the emails. The topic name may be the text string from the subject header of a majority of the emails within the group.

Step 110 represents building the transcript document 84. More specifically, building the transcript document 184 may include inserting blocks of text identified as unique content, redundant content, and headers from each of the emails within the group into applicable places of a transcript document template.

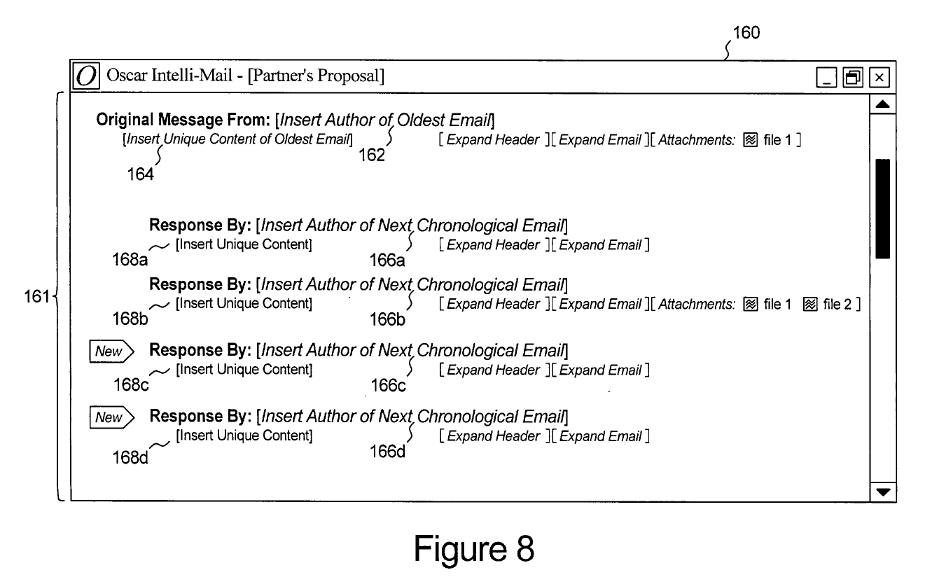

Referring briefly to FIG. 8, an exemplary transcript document template 160 is shown. The template 160 includes outline text content 161 with embedded formatting tags to provide the look of a conversation transcript. Within the template 160 are locations into which text strings extracted during steps 140 and 142 are inserted to complete the transcript. For example, the text string of the from header of the oldest email is inserted at field 162 to represent the author of the original email in the group. The unique contents of the original email is then inserted at field 164. The text string of the from header of each following email is then inserted in a field 166a-166n in chronological order representing the author of each next sequential email. The unique contents of each email is inserted in fields 168a-168n.

Returning to FIG. 6, step 112 represents writing the transcript document 84 to a location for viewing by the user. This may include writing to a specified file or may include writing to the inbox 30. Step 114 represents flagging the transcript document 184 as new (by formatting the title in bold, a different text color, or other wise making the transcript document 184 or the link to the transcript document appear different) so that the user may readily recognize it as new.

Step 116 represents a determination whether a topic folder corresponding to the new transcript document 84 already exists within the topic folder 34. If not, step 118 represents creation of a topic folder by the management engine 46 within the topic folders 34. Step 122 represents moving the group of emails to the new topic folder.

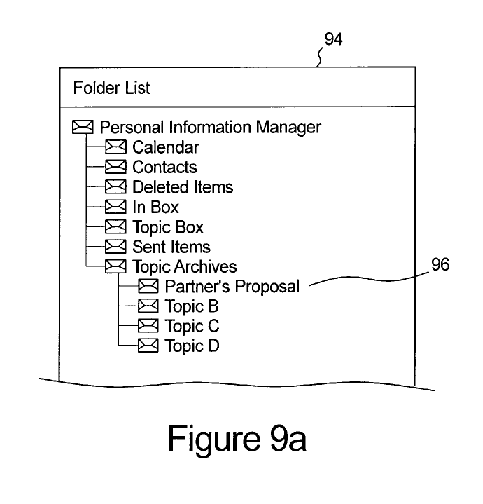

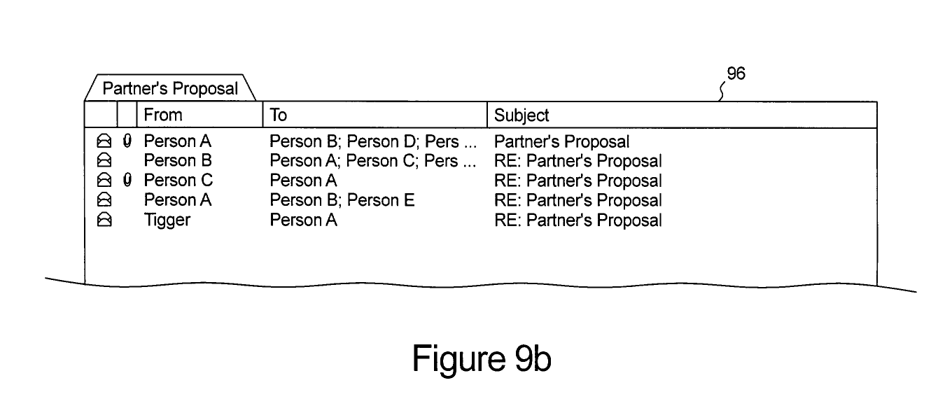

Turning to FIGS. 9a and 9b, in conjunction with FIG. 3 folder organization 94 in accordance with the present invention is shown. The email management engine 40 functions to move each of the emails that is combined into a transcript document 84 or transcript email 85 (FIGS. 4a or 4b) into a single folder that is associated with the transcript. For example topic folder 96 will include each of the five sequential emails that are used to generate topic file 84 and such five sequential emails will be deleted from the inbox and the sent box files. FIG. 6 shows each of the five sequential emails in the folder labeled Partners Proposal.

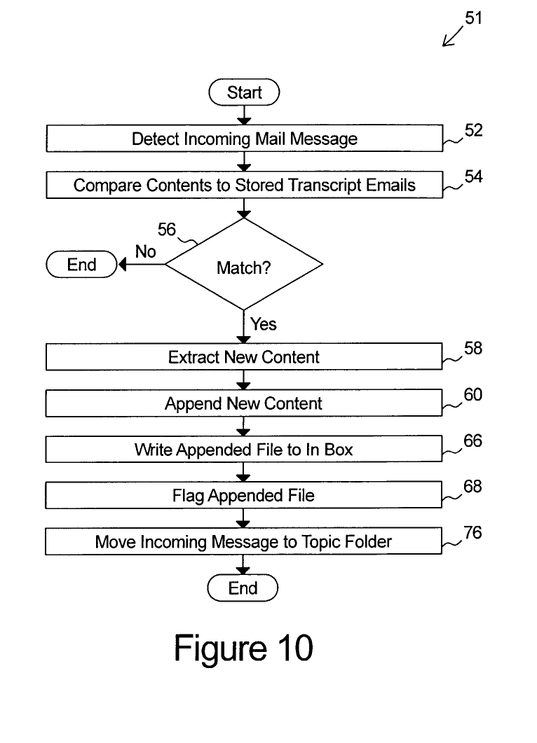

The flow chart of FIG. 10 represents steps performed by the email management engine 40 upon receipt of a new email message from the service provider 12 (FIG. 3) that may be related to a group of email messages for which a transcript document already exists.

Step 52 represents detecting an incoming e-mail. This step may include either directly receiving the email message file from the email service provider 12 or may include detecting a new email message in the in box file.

Step 54 represents comparing the contents of the incoming email received at step 52 to the contents of each existing transcript email 85. The comparison may include some or all of the steps discussed with reference to FIG. 7.

If the comparison does not yield a match at step 56, the engine terminates and the new email message is simply stored in the inbox for operator viewing. However, if there is a match, step 58 represents extracting the unique content portion of the new email and step 60 represents generating an appended transcript email. The appended transcript email includes the transcript email 85 along with the unique content portion of the email appended thereto in chronological order.

Step 66 represents writing the appended transcript email to the inbox so that it can be viewed by the operator. Step 68 represents flagging the appended transcript email as containing new material such that the operator is prompted to open the appended transcript email. Typical flagging methods include bold text, other colored text, or a special icon. Step 76 represents moving the new incoming message to the topic folder.

It should be appreciated that the teachings of the present invention provide for a coherent system for integrating and managing sequential email messages related to topics. Although the invention has been shown and described with respect to certain preferred embodiments, it is obvious that equivalents and modifications will occur to others skilled in the art upon the reading and understanding of the specification. For example, while the exemplary embodiment is shown in combination with, or integrated with, an email client, it is envisioned that those skilled in the art may combine the teachings of the present invention with the email service provider system. The present invention includes all such equivalents and modifications, and is limited only by the scope of the following claims.

What is claimed is:

1. An email transcript engine comprising:
a comparison engine for comparing text within a body of at least two email files to identify a related group of email files, wherein the related group of email files comprises at least two email files that include an identical string of text;
an extraction engine for determining:
a unique content portion of the body of each of the email files within the related group, the unique content portion being the portion of the body input by the sender of the email, and
a redundant content portion of the body of each of the email files within the related group, the redundant content portion being the portion of the body copied from a previous email file in response to activation of one of the email client software's “forward”, “reply”, and “reply-all” controls;
a file management engine for generating a transcript document, the transcript document comprising a chronological sequence of each unique content portion of the body portion of each of the email files within the related group.

2. The email transcript engine of claim 1, wherein the transcript document further comprises an identification of the author of each unique content portion in association with such unique content portion.

3. The email transcript engine of claim 1, wherein the transcript document further comprises an active link associated with each unique content portion of each body portion and providing a link to the redundant content portion of such body portion.

4. The email transcript engine of claim 1, wherein:
at least one of the at least two emails is located within an inbox file controlled by an email client; and
at least one of the at least two emails is located within a sent items file controlled by an email client.

5. The email transcript engine of claim 1, wherein the file management engine further generates a transcript email that includes the transcript document in a body portion of the transcript email.

6. The email transcript engine of claim 5, wherein the file management engine stores the transcript email within an email file storage controlled by an email client.

7. The email transcript engine of claim 6, wherein the file management engine further:
creates a new directory associated with the related group of email files; and
moves each of the related group of email files to the new directory.

8. An email client comprising:
means for exchanging email messages with a remote email server;
means for storing email messages received from a remote server in a file structure that includes an inbox file;
means for storing email messages sent to a remote server in a sent items file within the file structure;
a comparison engine for comparing text within a body of a plurality of email messages stored within the file structure to identify a related group of email files, wherein the related group of email files comprises at least two email files that include an identical string of text;
an extraction engine for determining:
a unique content portion of the body of each of the email files within the related group, the unique content portion being the portion of the body input by the sender of the email, and
a redundant content portion of the body of each of the email files within the related group, the redundant content portion being the portion of the body copied from a previous email file in response to activation of one of the email client software's “forward”, “reply”, and “reply-all” controls;
a file management engine for generating a transcript document, the transcript document comprising a chronological sequence of each unique content portion of the body portion of each of the email files within the related group.

9. The email client of claim 8, wherein the transcript document further comprises an identification of the author of each unique content portion in association with such unique content portion.

10. The email client of claim 8, wherein the transcript document further comprises an active link associated with each unique content portion of each body portion and providing a link to the redundant content portion of such body portion.

11. The email client of claim 8, wherein:
at least one of the at least two emails is located within the inbox file; and
at least one of the at least two emails is located within the sent items file.

12. The email client of claim 8, wherein the file management engine further generates a transcript email that includes the transcript document in a body portion of the transcript email.

13. The email client of claim 12, wherein the file management engine stores the transcript email within the inbox.

14. The email client of claim 13, wherein the file management engine further:
creates a new directory associated with the related group of email files; and
stored each of the related group of email files to the new directory.

15. A method of email management, the method comprising:
receiving an email from a remote email service provider;
retrieving a stored transcript email that is related to the incoming email;
comparing contents of the email with the transcript email to identify a unique content portion of the body of the email and to identify a redundant content portion of the body of the email; and
creating an appended transcript document by appending the unique content portion of the email to the transcript document.

16. The method of claim 15, further including:
storing the email in a file directory associated with the transcript document and which includes a plurality of other emails associated with the transcript document.

17. The method of claim 5, wherein the step of retrieving a stored transcript document includes:
comparing a text string from the email with text within each of a plurality of transcript documents.
retrieving a transcript document that includes a text string that matches the text string from the email.

18. The method of claim 17, further comprising storing the appended transcript document in an inbox folder.

19. The method of claim 18, further comprising moving the transcript document to a deleted items folder.
